(19) United States
(12) Patent Application Publication
(10) Pub. No.: US 2011/0174699 A1
(43) Pub. Date: Jul. 21, 2011

(54) Metal detecting gold pan

(75) Inventor: Timothy Ray Friend, Red Bluff, CA (US)

(73) Assignee: Timothy Ray Friend, Fortuna, CA (US)

(21) Appl. No.: 12/925,983

(22) Filed: Nov. 2, 2010

Related U.S. Application Data
(60) Provisional application No. 61/257,787, filed on Nov. 3, 2009.

(51) Int. Cl. B03B 5/00

(52) U.S. Cl. 209/447

(57) ABSTRACT

A metal detecting gold pan for speeding the location, identification and recovery of ferrous or non ferrous metals from parent materials. Metal detecting electronics and sensors in proximity to, connected by cord to, and imbedded in the body of the pan sense and identify metals inside or outside the pan. The metal detecting gold pan is used in the traditional manner, using either wet or dry methods for materials separation. Metals consolidating in the interior of the pan are electronically sensed and identified. Metal bearing parent material external to the pan may be located by using a sensor in the bottom of the pan. Time and effort to reduce overburden and identify materials is greatly reduced during the panning process.

### RELATED APPLICATIONS

The present application is a continuation application of U.S. provisional patent application Ser. No. 61/257,787, filed Nov. 3, 2009, included by reference herein and for which benefit of the priority date is hereby claimed.

### FIELD OF THE INVENTION

The present invention relates to gold pans and, more particularly, to a gold pan with metal detecting capabilities.

### BACKGROUND OF THE INVENTION

Paning for valuable metals using a hand held gold pan involves picking a spot on the planet where metals are suspected by a prospector to exist, placing material from the earth in the pan and manually agitating these materials to cause separation in order of density. or specific gravity. The operator of the pan may or may not add water to the mix to facilitate washing away of light materials. The object is to trap the heavier materials in the bottom of the pan for collection, while lighter non metallic materials are washed away or manually discarded. Metals such as gold, platinum and silver are some of the more common but not the only metals that are collected by gold panning.

The problems involved with the use of a gold pan to reduce material for the purpose of separating and recovering valuable metals are multiple; The ability to locate a prospective area of parent material, bearing valuable metals is a hit and miss affair unless the prospector has previous experience with gold panning, and or has knowledge to some degree of geology.

Once a metal bearing area of soil, gravel or other materials has been located, the traditional, iconic gold pan is loaded with material, and the act of separating metals from non-metallic material called “panning” begins. The time and effort required to assess the metal content of the sample being reduced, are considerable and mandatory. The operator may often as not spends minutes or hours unsuccessfully reducing material that will yield no valuable metals. This causes much wasted time.

Once materials reduction is accomplished through use of the gold pan, the success of the effort depends on the ability of the operator to visually identify valuable metals. This ability may be hampered by a coating of, or contamination of valuable metals, by minerals or other substances, altering their appearance so as not to be visually recognizable. Another problem is that the metals in the bottom of the pan are shrouded from view by the overburden of non metallic materials contained in the pan. This results in discarding valuable metals and wasted time when the metals are discarded by mistake because they are not recognized by the operator as being metal.

Determining ferrous from non ferrous metals visually is another problem. While the two may look similar, the non ferrous metals are not usually what are being separated for collection. Non ferrous metals such as gold, silver, platinum, copper, nickel and others are usually what are being sought. Valuable metals are often found in the presence of iron which is a ferrous metal, and a concentration of iron warrants further attention to a prospective area.

The issue of time spent reducing materials with a gold pan for the identification and recovery of valuable metals, is accurately expressed by the old saying, “Time is money”. Many hours may be spent reducing material, only to find there are only non valuable ferrous metals in the bottom of the pan.

The traditional hand held gold pan has seen solutions to the problem of consolidating, separating and identifying metals from other materials, approached through the use of mechanical means. There have been riffles, flukes, agitator knobules, water delivery cups, and other mechanical means applied to the body of the traditional gold pan. All are attempts to increase the speed and efficiency of the act of “panning for gold”.

Examples of these solutions may be found in U.S. Pat. No. 3,855,119 (Gold Pan With Riffles)

U.S. Pat. No. 5,447,239 (Gold Pan With Flukes)

U.S. Pat. No. 5,788,293 (Gold Pan With Agitator Knobules)

U.S. Pat. No. 5,957,303 (Gold Pan With Water Delivery Cups)

Examples of gold pan history, design and the panning process, may be seen at: http://www.keeneengineering.com/pamphlets/howpan.html

Examples of metal detectors may be seen at: http://www.tesoro.com/product/detectors/

Unlike the metal detecting gold pan, all other devices called gold pans, and being hand held, have relied on mechanical means of one sort or another to trap metals so as to concentrate them in sufficient quantity, to be visually identified and collected. This is normally accomplished through manually reducing the overburden material covering the heavier metals on the bottom of the pan through the relatively slow process known as panning.

There are no previous improvements to the gold pan which allow the prospector to electronically “see” metals collecting in the bottom of the pan, without taking the time to reduce the overburden. Nor do they address the issue of time spent reducing out the overburden material, to finally determine if there are metals in the bottom of the pan. They do not speed this process, and they do not identify collected metals, as ferrous or non ferrous, as does the metal detecting gold pan.

Other solutions to improving the efficiency of the gold pan, do not address the problem of locating a prospective area bearing valuable metals, as does the metal detecting gold pan.

### SUMMARY OF THE INVENTION

In accordance with the present invention, there is provided a metal detecting gold pan with the capability to detect ferrous, or non ferrous metals confined to the interior of, or in proximity to the gold pan. This hand held gold pan has metal detection electronics, including sensors, power source, and associated circuitry integral to, or in proximity to the body of the gold pan. Power source may be rechargeable, or throw away batteries.

The gold pan shape is round or other shape, having a sloping wall that terminates at the bottom of the pan. The bottom of the pan is of smaller dimension than the top rim.

The pan body is made of plastic or other non metallic material, and constructed so as to house the electronics, sensors, circuitry, power supply and optional wireless communications, so as to be integral or in proximity to the body of the gold pan. This is accomplished through node structures that double as handles, and through encapsulation by the body of the pan when it is moulded. Nodes and circuitry may also be installed using adhesives and coatings.

The bottom of the metal detecting gold pan is equipped with two sensors; The surveying sensor, integral to the bottom of the pan, is of a diameter smaller than the bottom of the pan. It is oriented to sense and locate metals outside the pan. This is accomplished by scanning, or waving the bottom of the pan over soil, rock or other materials.

A recovery sensor is installed in the bottom of the metal detecting gold pan, and is oriented so as to sense the presence of metals contained inside the pan, primarily but not limited to the juncture of the wall and bottom of the pan.

Circuitry integral to the body of the pan, either through encapsulation by the structure of the pan, or attachment by means of adhesive or other means, allow electronic communication and distribution of power between sensors and metal detection electronics.

Metal detection electronics are housed in a power/electronics node integral to the body, and, or in proximity to the metal detecting gold pan. Metal detection electronics housed in a peripheral metal detection electronics/power pack, may also be connected to the power/electronics node peripherally, via a power/data cord, or by optional wireless communication.

A peripheral power/electronics pack houses a battery power source, metal detection electronics and optional wireless communication electronics, It is equipped with a power/data cord and an earphone connection point.

Controls for power and function of electronics are dictated by choice of particular brand and type of metal detection electronics chosen for application.

It would be advantageous to provide a metal detecting gold pan to speed the process of reducing materials for the collection of metals, through the process known as “gold panning”.

It would also be advantageous to provide a metal detecting gold pan, having the capability to identify ferrous and non ferrous metals.

It would further be advantageous to provide a metal detecting gold pan, having the capability to locate metals in the ground, and in proximity to the metal detecting gold pan.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left perspective view of a metal detecting gold pan in accordance with the invention;

FIG. 2 is a top detail view of a metal detecting gold pan in accordance with the invention;

FIG. 3 is a bottom detail view of a metal detecting gold pan in accordance with the invention;

FIG. 4 is a left plan view of a metal detecting gold pan in accordance with the invention;

FIG. 5 is a top view of a metal detecting gold pan in accordance with the invention in use; and

FIG. 6 is a perspective view showing of the overall invention view of a metal detecting gold pan in accordance with the invention, in use by operator with peripheral power supply and metal detection electronics.

For purposes of clarity and brevity, like elements and components will bear the same designations and numbering throughout the Figures.

### DESCRIPTION OF THE PREFERRED EMBODIMENT

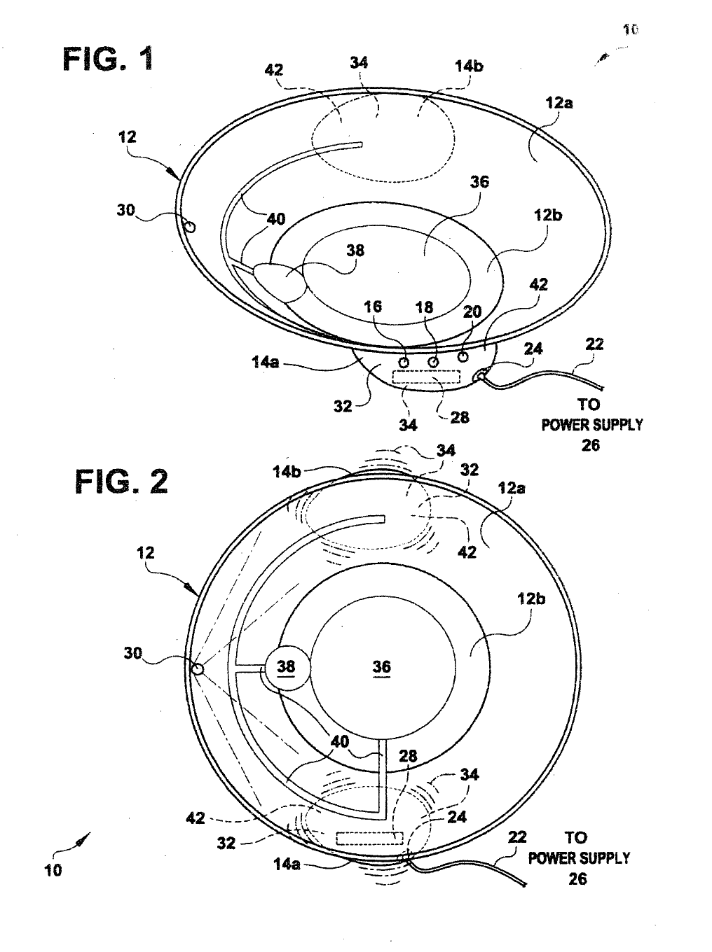

FIG. 1 is a left perspective view of the metal detecting gold pan 10, in accordance with the invention for the rapid identification and collection of metals contained by the interior of the pan, or outside the pan. The gold pan 12 is constructed through an injection molding process and is plastic. The side wall 12a of the metal detecting gold pan 10 is shown with metal detection electronics 42 housed in the ergonomic power/electronics node 14a. This node is also injection molded of plastic. It may be installed on the outside wall of the pan by use of waterproof adhesives, thermal bonding, or may be molded as part of the pan to keep water out. Advanced injection molding techniques allow for total encapsulation of parts included in the metal detecting gold pan 10, at the time of molding. If this node is to be bonded to the wall of the pan, all connections from electronics contained in the node, to circuitry 40 integral to the body of the pan, for sensors, signalling devices and the metal detection electronics 42, must be made before installation of the ergonomic power/electronics node 14a. This node also functions as a handle when operating the metal detecting gold pan 10 This node provides housing for the on, off power switch 16, mode switch 18, vibrating signal device 34, and sensor selection switch 20. It also houses a power/data port 24 for connection to the power/data cord 22. A waterproof removable cover, sealed by an O-ring, and secured with stainless steel screws or other fasteners, allows access to the battery 28 compartment, for installing or changing the battery 28 that is housed in the ergonomic power/electronics node 14a. All components including the node are waterproof by virtue of method of installation, or construction of individual components manufactured as waterproof.

The on, off power switch 16, mode switch 18, and sensor selection switch 20 are of a type known as blister switches because they are covered with a plastic material to seal them, looking much like a blister. They are normally open switches used to trigger different functions by press and release action. They are mounted into the body of the ergonomic power/electronics node 14a just below, and slightly shrouded by the lip of the gold pan 12. as seen in FIG. 4. This position allows a certain amount of protection, and they may be actuated by the thumb or fingers of the operator without significantly altering his or her grip on the pan, while agitating the contents of the pan during the process commonly known as “panning”,

The on, off power switch 16 routes electrical power from the battery 28, to all power consuming devices and circuitry 40 integral to, and those that are connected peripherally to the metal detecting gold pan 10, via the power/data cord 22. The power/data cord 22 must be light, flexible and supple, to reduce feedback of motion created by the act of “panning”, through the cord to peripheral devices, causing unwanted motion. It must also be kink resistant, damage resistant and of a diameter to meet these criteria, while also being of sufficient diameter to contain all needed circuitry 40. The exact number of wires contained in the cable, and appropriate cable connection ends are dictated by the brand and type of the metal detection electronics 42 chosen for installation.

The mode switch 18 is used to toggle between various function modes of the metal detecting electronics, as dictated by the specific brand or type of metal detection electronics 42 installed. Modes may include but not be limited to such functions as detection of ferrous metals, detection of non ferrous metals, or detection of ferrous and non ferrous metals simultaneously.

The sensor selection switch 20 allows the operator of the metal detecting gold pan 10 to choose which, of one or more sensors installed into, or in proximity to the body of the invention will be selected for utilization at various stages of the prospecting process. The selected sensor signal to the metal detection electronics 42, is then processed. The operator is notified of the presence of metal via one of the signaling devices. The most commonly used signal is the audio signaling device 32. It is of pezio electric design, and is loud enough to be heard above normal background noise. It is activated by the metal detection electronics 42. If background noise is too loud for the pezio device to be heard, earphones may be connected to the peripheral electronics/power pack. The audio, light source, or vibrating signal device 34 may be selected

The power/data port 24 allows the operator of the gold pan 12 to connect the peripheral electronics/power pack 26 to the ergonomic power/electronics node 14a by use of the power/data cord 22. This port is waterproof and is sealed by the use of a screw—in waterproof plug when not in use. Advances in deep water exploration have spawned many waterproof cable connections that are applicable to this port, as well as to the power/data cord 22 ends.

FIG. 2 is a top detail view of the metal detecting gold pan 10. It shows the circuitry 40, surveying sensor 36, recovery sensor 38 and light source signaling device 30, integral to the side wall 12a and bottom 12b of the gold pan 12.

Circuitry 40 must be of the type required by the choice of brand and type of electronics to be installed. It is responsible for linking all electrical components to the metal detection electronics 42.

Circuitry 40 is encapsulated into the body of the gold pan 12 at the time of injection molding, or may be bonded to the exterior by use of adhesives or thermal bonding. The circuitry 40 must be protected from damage, by encapsulation in the body of the gold pan 12, or by a covering if installed on the exterior of the pan. Circuitry 40 and sensors as well as other components will interfere with the materials reduction, or “panning” process if they protrude into the interior of the pan. Sensors are installed flush with the interior surface of the pan.

Circuitry 40 may be of a ribbon type, similar to that found used in computers, or singular wires, of a gauge appropriate to facilitate complete encapsulation in the body of the gold pan 12 at the time of injection molding. Ribbon circuits are flat. flexible groupings of multiple wires, and may be laid in a mold, to conform to many different shapes. They are connected to components by soldering or other means, to be dictated by the particular brand and type of components to be installed into the metal detecting gold pan 10.

The light source signaling device 30 is optional. It is a light emitting diode oriented to the front center of the lip of the pan, so as to be visible by the operator while “panning”. It's purpose is to alert the gold pan 12 operator when metals are present in close proximity to, or in contact with the recovery sensor 38. This light source must be bright enough to be seen in daylight conditions, and rugged, as this location is prone to damage if the pan is dropped or struck by accident. The light source signal device, and associated circuitry 40, is best installed by encapsulation techniques used at the time of injection molding of the metal detecting gold pan 10. It is to be connected to, and activated by the metal detection electronics 42.

The surveying sensor 36 is used to locate an area containing metals. It is of coil construction, as is used in most metal detectors today. The actual specifications for the coil are dictated by the brand and type of metal detection electronics 42 chosen to be installed, and the diameter of the bottom 12b of the gold pan 12. This sensor is of a diameter allowing it to be encapsulated in the bottom 12b of the pan, or applied to the external surface of the bottom 12b of the pan. If not encapsulated, it may be fastened by the use of adhesives, or thermal bonding.

The surveying sensor 36, used to detect ferrous or non ferrous metals is of coiled wire construction as is found on most metal detectors used by the public for coin and jewelry hunting, relic hunting, and prospecting for valuable metals. It is used similarly, as described at FIG. 6. It is mounted in the bottom 12b structure of the pan below the recovery sensor 38 and is oriented to search for metals below and exterior to the metal detecting gold pan 10. The surveying sensor 36 has the capability to locate metals at the surface of, or below the surface of the ground. The rule of thumb in the metal detecting industry is, “The larger the diameter of the coil, the deeper the metal detecting signal will penetrate into the ground”. An acceptable depth of ground penetration for this application is three or more inches.

The recovery sensor 38 is used for detecting, and identifying the type of small quantities of metals contained in the bottom 12b of the metal detecting gold pan 10. It is installed in the bottom 12b of the gold pan 12, at the juncture of the side wall 12a and the bottom 12b of the pan, so as to be oriented to the front, (or 12 o'clock position) when the metal detecting gold pan 10 is in use. It is mounted flush with the bottom 12b of the gold pan 12 so as not to protrude into the interior of the pan.

The recovery sensor 38 is of a small diameter, and is thin enough to be mounted in the bottom 12b of the metal detecting gold pan 10, without adding undue thickness to the bottom 12b of the pan when it is installed along with the surveying sensor 36.

The exact diameter and thickness of the recovery sensor 38 is also dictated by the brand and type of metal detecting electronics installed. A diameter in the range of ½ to 2 inches is preferable. This allows for sensing the presence of metals early in the process of separating and reducing the parent materials from metals. This small diameter sensor monitors the area where metals will begin to collect, as the materials contained in the gold pan 12 are agitated to induce the metals to migrate to the bottom 12b of the metal detecting gold pan 10.

Construction of the recovery sensor 38 may be of the conventional coil, or other type. It should be of sufficient sensitivity to detect metal quantities with weights of ½ grain, or less.

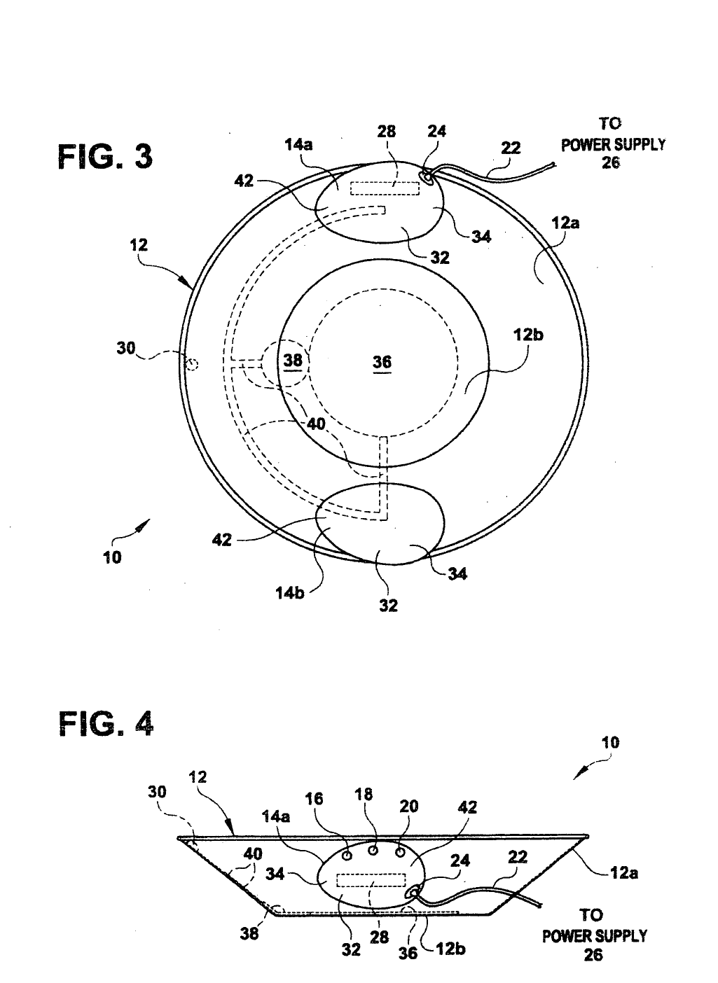

FIG. 3, is a bottom 12b detail view of the metal detecting gold pan 10, showing location of the surveying sensor 36, recovery sensor 38, ergonomic electronics/power node, and associated circuitry 40, encaplulated in, or bonded to the body of the metal detecting gold pan 10.

FIG. 4, is a left plan view of the metal detecting gold pan 10 showing the location of the ergonomic power/electronics node and control buttons, with power/data cord 22 connected.

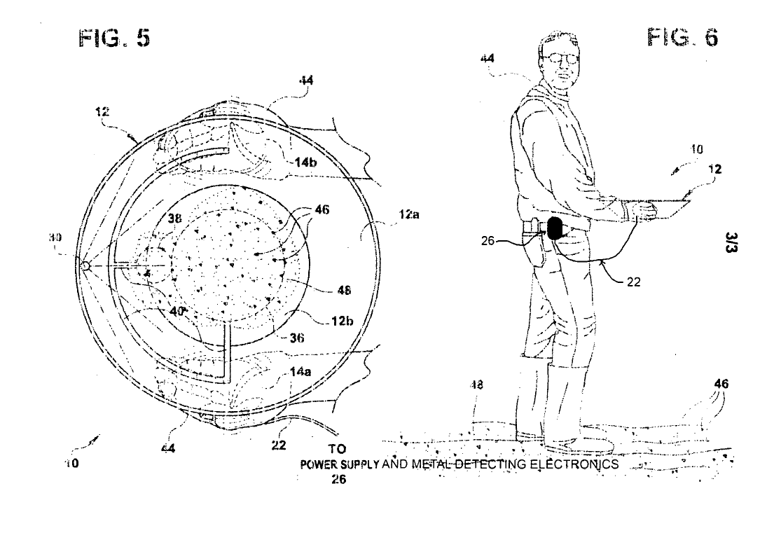

FIG. 5 is a top view of the metal detecting gold pan 10 in use. Shown, is the hand position traditionally used by the prospector/operator for “panning”. The recovery sensor 38 is oriented to the front and center position, where the most rapid consolidation of metals occurs during the reduction, or “panning” process. Also shown are metal bearing parent materials 48 and valuable metals 46 being contained in the metal detecting gold pan 10.

FIG. 6 is a perspective view of the metal detecting gold pan 10 in use by the prospector/operator 44 connected via the power/data cord 22, to the peripheral electronics/power pack 26.

The peripheral electronics/power pack 26 is a water resistant or waterproof housing, containing electronics, and a battery 28 to power electronics. It is equipped with an on/off switch of blister design and is waterproof. The power/data cord 22 is hard wired to the peripheral electronics/power pack 26, The pack also houses a connection to accommodate the operators use of earphones, for monitoring faint audio signals indicating the presence of minute quantities of metal in proximity to the surveying sensor 36, or the recovery sensor 38, mounted in the metal detecting gold pan 10

The peripheral electronics/power pack 26 may be worn at the waist by use of a belt clip. If the operator is wearing clothing that would prohibit comfortable positioning of the pack, it may be worn hung around the operators neck by a lanyard.

Depending on the brand and type of metal detection electronics 42 installed in the metal detecting gold pan 10, this peripheral electronics/power pack 26 may contain all, or part of the necessary electronics needed for the system to function. If usable space in the body of the gold pan 12 is not sufficient for the installation of all desired electronics, they may be installed into the peripheral electronics/power pack 26, and connected to the ergonomic power/electronics node 14a via the power/data cord 22.

This design factor allows for optional electronics, such as wireless communications equipment, GPS equipment, data recording equipment or other electronics to be installed for use in conjunction with the metal detection electronics 42.

The signal from surveying sensor 36 to the ground is shown.

In operation, metal jewelry or other metal objects are removed from the hands. The hand, or hands used to grip the metal detecting gold pan 10 while surveying, should be free of metallic objects, so as to avoid possible false, positive signals, for the presence of metals, being generated by these objects.

The metal detecting gold pan 10 is held by the operator in a bottom 12b down position. The on, off power switch is activated powering up the metal detection electronics 42, drawing power from the battery 28. The sensor selection switch 20 is activated to select the surveying sensor 36 for use, and activating the signal from surveying sensor 36. The metal detecting gold pan 10 is gripped in a comfortable manner as decided by the operator, and is oriented with the bottom 12b down. With the surveying sensor 36 now in use, and the mode switch 18 set to ferrous and non ferrous metals detection, the pan is lowered towards the earth, or other surface to be surveyed, until it reaches a distance that is as close to this surface as it can be, without making contact. The operator begins the survey, by sweeping the pan parallel to the surface being prospected, while maintaining a minimal distance (typically less than an inch), from the surface. Each sweep surveying a new swath of ground, adjacent to the previous.

If metals are present in parent material at or below the surface, within the range of detection (dictated by the choice of brand and type of electronics installed) the metal detection electronics 42 will signal the operator of their presence via earphones, vibrating signal device 34, audio signaling device 32, or light source signaling device 30. Upon detection of metals, if earphones or audio signalling device are in use, typically a beep, whoop, or clicking sound will be used to alert the operator, by audible signal.

Upon being alerted to the presence of metal in the area being surveyed, the mode switch 18 is used to select, non ferrous mode. This mode identifies the detected metals as having a non ferrous metals content, by cancelling the signal produced by the ferrous metals. By doing so, only the signals generated indicating the presence of non ferrous metals reach the operator.

Upon determining by electronic survey that the prospective area contains metals, the sensor selection switch 20 is used to activate the recovery sensor 38. Switching to the recovery sensor 38 also powers down the surveying sensor 36. The mode switch 18 is activated to set the metal detecting electronics to detect ferrous and non ferrous metals.

A quantity of known metal bearing material, having been identified by the survey, is transferred to the interior of the metal detecting gold pan 10. Water may be added to the mix to aid in separating the materials through a washing effect. With the recovery sensor 38 activated, the metal detecting gold pan 10 is held as shown in FIG. 5, with the recovery sensor 38 in the bottom 12b of the pan oriented to a forward, or twelve o'clock position. The metal detecting gold pan 10 is held so that the bottom 12b is sloped away from the operator. and downward toward the recovery sensor 38. The ergonomic nodes are cupped in the hands if desired. The material in the pan is then harshly agitated by a quick, forceful, combination of fore and aft, lateral, and or circular movement while maintaining the slope in the bottom 12b of the metal detecting gold pan 10. This causes the heavier metals in the parent material to gravitate downward through the lighter materials in the pan, and toward the juncture of the side wall 12a and bottom 12b, where the recovery sensor 38 is located.

The heavier metals will begin consolidating at the juncture, and on top of the recovery sensor 38. The sensor then detects these metals, and the metal detection electronics 42 alert the operator to their presence, using the signaling device selected by the operator. The metals in proximity to the recovery sensor 38 may then be identified as having, or not having a non ferrous metals content, by use of the mode switching capabilities of the metal detection electronics 42.

This is a very quick means of accomplishing identification of the valuable metals 46 in the bottom 12b of the metal detecting gold pan 10, as opposed to taking the time to manually reduce the overburden of unwanted material contained in the pan, and visually identify the collected metals.

Peripheral electronics, as dictated by brand and type for application, are connected to the metal detecting gold pan 10 via the power/data cord 22, to supplement existing electronic capabilities, or to add capabilities.

metal detection electronics 42

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A metal detecting gold pan for the purpose of rapidly locating, identifying and recovering metals confined to the interior of the gold pan, or in proximity to the metal detecting gold pan.
a gold pan with integrated metal detector for facilitating rapid identification of ferrous or non ferrous metals contained by, or in proximity to said gold pan, comprising:
means for detection and recovery of metals;
means for separating metals from other materials, housing metal detection electronics, circuitry;
means for housing circuitry imbedded in wall structure, physical support of electronics/power supply nodes, rigidly connected to said means for separating metals from other materials, housing metal detection electronics, circuitry;
means for processing signal input from sensors to detect presence of metals;
means for housing metal detecting electronics, battery, power/data port, rigidly connected to said means for processing signal input from sensors to detect presence of metals, and rigidly connected to said means for housing circuitry imbedded in wall structure, physical support of electronics/power supply nodes;
means for powering all electronic components, sealably housed to said means for housing metal detecting electronics, battery, power/data port, and flexibly connected to said means for processing signal input from sensors to detect presence of metals;
means for connecting ergonomic power/electronics node to power/data cord, sealably fitted to said means for housing metal detecting electronics, battery, power/data port;
means for housing sensors and circuitry, rigidly connected to said means for housing circuitry imbedded in wall structure, physical support of electronics/power supply nodes;
means for detection of metals, rigidly molded to said means for housing sensors and circuitry, and flexibly connected to said means for processing signal input from sensors to detect presence of metals;
means for detection of metals, rigidly embedded to said means for housing sensors and circuitry, and flexibly connected to said means for processing signal input from sensors to detect presence of metals;
means for connecting electronic components, flexibly connected to said means for detection of metals, flexibly connected to said means for detection of metals, flexibly connected to said means for processing signal input from sensors to detect presence of metals, and flexibly embedded to said means for separating metals from other materials, housing metal detection electronics, circuitry;
means for housing battery, metal detection electronics, wireless communications connected peripherally;
means for connecting peripheral electronics/power pack to ergonomic power/electronics node
sealably connected to said means for housing battery, metal detection electronics, wireless communications connected peripherally, and sealably connected to said means for connecting ergonomic power/electronics node to power/data cord;
means for switching power to electronics on or off, sealingly inserted to said means for housing metal detecting electronics, battery, power/data port;
means for selecting surveying or recovery sensor, sealingly embedded to said means for housing metal detecting electronics, battery, power/data port;
means for switching meal detection modes, sealingly embedded to said means for housing metal detecting electronics, battery, power/data port; and
means for signaling presence of metal detected, sealingly embedded to said means for housing metal detecting electronics, battery, power/data port, and flexibly connected to said means for processing signal input from sensors to detect presence of metals.

2. The metal detecting gold pan in accordance with claim 1, wherein said means for detection and recovery of metals comprises a metal detecting gold pan.

3. The metal detecting gold pan in accordance with claim 1, wherein said means for separating metals from other materials, housing metal detection electronics, circuitry comprises a houses electronics, houses circuitry, non-water soluble, plastic, hand held, rigid, diameter 4 to 24 inches gold pan.

4. The metal detecting gold pan in accordance with claim 1, wherein said means for housing circuitry imbedded in wall structure, physical support of electronics/power supply nodes comprises a houses circuitry, physically supports electronics/power nodes, rigid side wall.

5. The metal detecting gold pan in accordance with claim 1, wherein said means for processing signal input from sensors to detect presence of metals comprises a waterproof, rugged, wireless capability to peripheral equipment metal detection electronics.

6. The metal detecting gold pan in accordance with claim 1, wherein said means for housing metal detecting electronics, battery, power/data port comprises an integral to gold pan wall, metal detection electronics, battery, power/data port, control buttons, circuitry, waterproof, ergonomically designed, made of plastic ergonomic power/electronics node.

7. The metal detecting gold pan in accordance with claim 1, wherein said means for powering all electronic components comprises a non rechargeable battery.

8. The metal detecting gold pan in accordance with claim 1, wherein said means for connecting ergonomic power/electronics node to power/data cord comprises a waterproof connection power/data port.

9. The metal detecting gold pan in accordance with claim 1, wherein said means for housing sensors and circuitry comprises a houses sensors, houses circuitry bottom.

10. The metal detecting gold pan in accordance with claim 1, wherein said means for detection of metals comprises a senses metals electronically, coil construction, waterproof, rugged surveying sensor.

11. The metal detecting gold pan in accordance with claim 1, wherein said means for detection of metals comprises a senses metals electronically, waterproof recovery sensor.

12. The metal detecting gold pan in accordance with claim 1, wherein said means for connecting electronic components comprises an embedded, flexible, waterproof, flat, thin circuitry.

13. The metal detecting gold pan in accordance with claim 1, wherein said means for housing battery, metal detection electronics, wireless communications connected peripherally comprises a waterproof, metal detection electronics, power source, power/data cable connection, earphone connection, wireless communications electronics peripheral electronics/power pack.

14. The metal detecting gold pan in accordance with claim 1, wherein said means for connecting peripheral electronics/power pack to ergonomic power/electronics node
comprises a waterproof connection ends, flexible, small diameter, kink resistant, damage resistant power/data cord.

15. The metal detecting gold pan in accordance with claim 1, wherein said means for switching power to electronics on or off comprises a waterproof, blister type, pushbutton on, off power switch.

16. The metal detecting gold pan in accordance with claim 1, wherein said means for selecting surveying or recovery sensor comprises a waterproof, blister type, pushbutton sensor selection switch.

17. The metal detecting gold pan in accordance with claim 1, wherein said means for switching meal detection modes comprises a waterproof, blister type, pushbutton mode switch.

18. The metal detecting gold pan in accordance with claim 1, wherein said means for signaling presence of metal detected comprises a produces audible signal, waterproof audio signaling device.

19. A metal detecting gold pan for the purpose of rapidly locating, identifying and recovering metals confined to the interior of the gold pan, or in proximity to the metal detecting gold pan.
a gold pan with integrated metal detector for facilitating rapid identification of ferrous or non ferrous metals contained by, or in proximity to said gold pan, comprising:
a metal detecting gold pan, for detection and recovery of metals;
a houses electronics, houses circuitry, non-water soluble, plastic, hand held, rigid, diameter 4 to 24 inches gold pan, for separating metals from other materials, housing metal detection electronics, circuitry;
a houses circuitry, physically supports electronics/power nodes, rigid side wall, for housing circuitry imbedded in wall structure, physical support of electronics/power supply nodes, rigidly connected to said gold pan;
a waterproof, rugged, wireless capability to peripheral equipment metal detection electronics, for processing signal input from sensors to detect presence of metals;
an integral to gold pan wall, metal detection electronics, battery, power/data port, control buttons, circuitry, waterproof, ergonomically designed, made of plastic ergonomic power/electronics node, for housing metal detecting electronics, battery, power/data port, rigidly connected to said metal detection electronics, and rigidly connected to said side wall;
a non rechargeable battery, for powering all electronic components, sealably housed to said ergonomic power/electronics node, and flexibly connected to said metal detection electronics;
a waterproof connection power/data port, for connecting ergonomic power/electronics node to power/data cord, sealably fitted to said ergonomic power/electronics node;
a houses sensors, houses circuitry bottom, for housing sensors and circuitry, rigidly connected to said side wall;
a senses metals electronically, coil construction, waterproof, rugged surveying sensor, for detection of metals, rigidly molded to said bottom, and flexibly connected to said metal detection electronics;
a senses metals electronically, waterproof recovery sensor, for detection of metals, rigidly embedded to said bottom, and flexibly connected to said metal detection electronics;
an embedded, flexible, waterproof, flat, thin circuitry, for connecting electronic components, flexibly connected to said recovery sensor, flexibly connected to said surveying sensor, flexibly connected to said metal detection electronics, and flexibly embedded to said gold pan;
a waterproof, metal detection electronics, power source, power/data cable connection, earphone connection, wireless communications electronics peripheral electronics/power pack, for housing battery, metal detection electronics, wireless communications connected peripherally;
a waterproof connection ends, flexible, small diameter, kink resistant, damage resistant power/data cord, for connecting peripheral electronics/power pack to ergonomic power/electronics node
sealably connected to said peripheral electronics/power pack, and sealably connected to said power/data port;
a waterproof, blister type, pushbutton on, off power switch, for switching power to electronics on or off, sealingly inserted to said ergonomic power/electronics node;
a waterproof, blister type, pushbutton sensor selection switch, for selecting surveying or recovery sensor, sealingly embedded to said ergonomic power/electronics node;
a waterproof, blister type, pushbutton mode switch, for switching meal detection modes, sealingly embedded to said ergonomic power/electronics node; and
a produces audible signal, waterproof audio signaling device, for signaling presence of metal detected, sealingly embedded to said ergonomic power/electronics node, and flexibly connected to said metal detection electronics.

20. The metal detecting gold pan as recited in claim 19, wherein said gold pan is round.
